(19) United States
(12) Patent Application Publication
(10) Pub. No.: US 2004/0162211 A1
(43) Pub. Date: Aug. 19, 2004

(54) Fused silica having high internal transmission and low birefringence

(76) Inventors: Jeffrey J. Domey, Canton, NY (US); Johannes Moll, Painted Post, NY (US); Robert S. Pavlik JR., Corning, NY (US); Daniel R. Sempolinski, Painted Post, NY (US); Julie L. Ladison, Canton, NY (US); John E. Maxon, Canton, NY (US); Michael W. Linder, Wiesbaden (DE); Michael R. Heslin, Victor, NY (US)

Correspondence Address: CORNING INCORPORATED, SP-TI-3-1, CORNING, NY, 14831

(21) Appl. No.: 10/774,811

(22) Filed: Feb. 9, 2004

Related U.S. Application Data
(63) Continuation-in-part of application No. 10/255,731, filed on Sep. 25, 2002, now abandoned.
(60) Provisional application No. 60/325,950, filed on Sep. 27, 2001.

(51) Int. Cl. C03C 3/06

(52) U.S. Cl. 501/54

(57) ABSTRACT

Fused silica members having high internal transmission and low birefringence are disclosed. Methods of making such fused silica members are also disclosed. According to the present invention, fused silica members having an internal transmission equal to or greater than 99.65%/cm at 193 nm and having an absolute maximum birefringence along the use axis of less than or equal to 0.75 nm/cm are provided.

### CROSS REFERENCE TO RELATED APPLICATION

This application is a continuation-in-part of U.S. application Ser. No. 10/255,731, filed Sep. 25, 2002, which claims priority from U.S. Provisional Application Ser. No. 60/325,950, filed Sep. 27, 2001.

### FIELD OF THE INVENTION

This invention relates to fused silica optical members and production of optical members exhibiting improved properties, including, but not limited to, high internal transmission and low birefringence.

### BACKGROUND OF THE INVENTION

As practiced commercially, fused silica optical members such as lenses, prisms, photomasks and windows, are typically manufactured from bulk pieces of fused silica made in a large production furnace. In overview, silicon-containing gas molecules are reacted in a flame to form silica soot particles. The soot particles are deposited on the hot surface of a rotating or oscillating body where they consolidate to the glassy solid state. In the art, glass making procedures of this type are known as vapor phase hydrolysis/oxidation processes, or simply as flame hydrolysis processes. The bulk fused silica body formed by the deposition of fused silica particles is often referred to as a “boule,” and this terminology is used herein with the understanding that the term “boule” includes any silica-containing body formed by a flame hydrolysis process.

Boules typically having diameters on the order of five feet (1.5 meters) and thicknesses on the order of 5-10 inches (13-25 cm) can be routinely produced in large production furnaces. Multiple blanks are cut from such boules and used to make the various optical members referred to above. The principal optical axis of a lens element made from such a blank will also generally be parallel to the boule's axis of rotation in the furnace. For ease of reference, this direction will be referred to as the “axis 1” or “use axis”.

As the energy and pulse rate of lasers increase, the optical members such as lenses, prisms, photomasks and windows, which are used in conjunction with such lasers, are exposed to increased levels of laser radiation. Fused silica members have become widely used as the manufacturing material for optical members in such laser-based optical systems due to their excellent optical properties and resistance to laser induced damage.

Laser technology has advanced into the short wavelength, high energy ultraviolet spectral region, the effect of which is an increase in the frequency (decrease in wavelength) of light produced by lasers. Of particular interest are short wavelength excimer lasers operating in the UV and deep UV (DUV) wavelength ranges. Excimer laser systems are popular in microlithography applications, and the shortened wavelengths allow for increased line densities in the manufacturing of integrated circuits and microchips, which enables the manufacture of circuits having decreased feature sizes. A direct physical consequence of shorter wavelengths (higher frequencies) is higher photon energies in the beam due to the fact that each individual photon is of higher energy. In such excimer laser systems, fused silica optics are exposed to high energy photon irradiation levels for prolonged periods of time resulting in the degradation of the optical properties of the optical members.

It is known that laser-induced degradation adversely affects the performance of fused silica optical members by decreasing light transmission levels, altering the index of refraction, altering the density, and increasing absorption levels of the glass. Over the years, many methods have been suggested for improving the optical damage resistance of fused silica glass. It has been generally known that high purity fused silica prepared by such methods as flame hydrolysis, CVD-soot remelting process, plasma CVD process, electrical fusing of quartz crystal powder, and other methods, are susceptible to laser damage to various degrees.

Optical members made from fused silica that are installed in deep ultraviolet (DUV) microlithographic scanners and stepper exposure systems must be able to print circuits having submicron-sized features within microprocessors and transistors. State-of-the-art optical members require high transmission, uniform refractive index properties and low birefringence values to enable scanners and steppers to print leading-edge feature sizes. Transmission, refractive index uniformity and birefringence are three unique ways to characterize the optical performance of lens material and are the two properties that consistently require improvement as DUV technologies are extended.

European patent application EP 1 067 092 discloses a quartz glass member having an internal transmittance of at least 99.6%/cm and a birefringence of up to 1 nm/cm. Although the quartz glass members described in European patent application EP 1 067 092 have a high internal transmittance, it would be desirable to provide a fused silica optical member that has a higher absolute minimum internal transmission, i.e., greater than or equal to 99.65%/cm and an absolute maximum birefringence less than or equal to 0.75 nm/cm. The assignee of the present application manufactures and sells a high purity fused silica under the trademark HPFS® Corning code 7980 having a minimum internal transmission of 99.5%/cm and a birefringence less than or equal to 0.5 nm/cm.

The above discussion reveals that there continues to be a need for improved fused silica glasses and methods for increasing their resistance to optical damage during prolonged exposure to ultraviolet laser radiation, in particular, resistance to optical damage associated with prolonged exposure to UV radiation caused by 193 and 248 nm excimer lasers. It would be particularly advantageous to produce fused silica glass that has improved minimum internal transmission, i.e., greater than or equal to 99.65%/cm, preferably greater than or equal to 99.75%/cm and low absolute maximum birefringence, i.e. less than or equal to 0.75 nm/cm, preferably less than or equal to 0.5 nm/cm, and does not require further treatment of the fused silica after production of the boules. Furthermore, it would be desirable to produce such glasses in high production yields.

### SUMMARY OF INVENTION

The invention relates to fused silica optical members having high resistance to optical damage by ultraviolet radiation in the wavelength range between 190 and 300 nm. According to one aspect, the fused silica member of the present invention has an internal transmission greater than or equal to 99.65%/cm at a wavelength of 193 nm, an absolute maximum birefringence along the use axis less than or equal to 0.75 nm/cm, H₂ content less than or equal to 5×10¹⁷ molecules/cm³, and OH content greater than 300 ppm.

According to another aspect of the invention, fused silica members are provided having internal transmission greater than or equal to 99.75%/cm at a wavelength of 193 nm and an absolute maximum birefringence along the use axis less than or equal to 0.5 nm/cm. According to this aspect, preferably the fused silica member has H₂ content less than or equal to 2.5×10¹⁷ molecules/cm³.

According to one aspect of the invention, the fused silica glass member has a refractive index homogeneity less than or equal to 1 ppm along the use axis. In another aspect of the invention, the fused silica member exhibits a change in transmittance of less than 0.005/cm (base 10 scale) after the member has been irradiated with 1×10¹⁰ shots of 193 nm laser at 2000 Hz and 1.0 mJ/cm²/pulse. The fused silica members of the present invention are suitable for use as a lens in a photolithographic system.

The fused silica members of the present invention will enable the production of lens systems exhibiting lower absorption levels within lens systems used in photolithographic equipment. Lower absorption will reduce lens heating effects, which impacts imaging performance, loss of contrast and throughput in photolithographic systems. The fused silica members of the present invention exhibit lower birefringence, which will minimize optical aberrations and improve the imaging performance of photolithographic systems.

Additional advantages of the invention will be set forth in the following detailed description. It is to be understood that both the foregoing general description and the following detailed description are exemplary and are intended to provide further explanation of the invention as claimed.

### BRIEF DESCRIPTION OF THE DRAWINGS

FIG. 1 is a graph of induced absorption versus number of pulses for fused silica produced according to the present invention; and

FIG. 2 is a schematic drawing illustrating the general type of furnace for producing fused silica glass in accordance with the present invention.

### DETAILED DESCRIPTION

According to the present invention, fused silica optical members having improved transmission, improved homogeneity and low absolute maximum birefringence along the use axis are provided. Fused silica optical members are cut from fused silica boules, the manufacture of which is described below.

The fused silica optical members can be made by the fused silica boule process. In a typical fused silica boule process, a process gas, for example, nitrogen, is used as a carrier gas and a bypass stream of the nitrogen is introduced to prevent saturation of the vaporous stream. The vaporous reactant is passed through a distribution mechanism to the reaction site where a number of burners are present in close proximity to a furnace crown. The reactant is combined with a fuel/oxygen mixture at the burners and combusted and oxidized at a temperature greater than 1700° C. The high purity metal oxide soot and resulting heat is directed downward through the refractory furnace crown where it is immediately deposited and consolidated to a mass of glass on a hot bait.

In one particularly useful embodiment of the invention, an optical member having high resistance to laser damage is formed by:

a) producing a gas stream containing a silicon-containing compound in vapor form capable of being converted through thermal decomposition with oxidation or flame hydrolysis to silica;

b) passing the gas stream into the flame of a combustion burner to form amorphous particles of fused silica;

c) depositing the amorphous particles onto a support; and

d) consolidating the deposit of amorphous particles into a transparent glass body.

Useful silicon-containing compounds for forming the glass blank preferably include any halide-free cyclosiloxane compound, for example, polymethylsiloxane such as hexamethyldisiloxane, polymethylcyclosiloxane, and mixtures of these. Examples of particularly useful polymethylcyclosiloxanes include octamethylcyclotetrasiloxane, decamethylcyclopentasiloxane, hexamethylcyclotrisiloxane, and mixtures of these.

In one particularly useful method of the invention, halide-free, cyclosiloxane compound such as octamethylcyclotetrasiloxane (OMCTS), represented by the chemical formula

—[SiO(CH₃)₂]₄—,

is used as the feedstock for the fused silica boule process, or in the vapor deposition processes such as used in making high purity fused silica for optical waveguide applications.

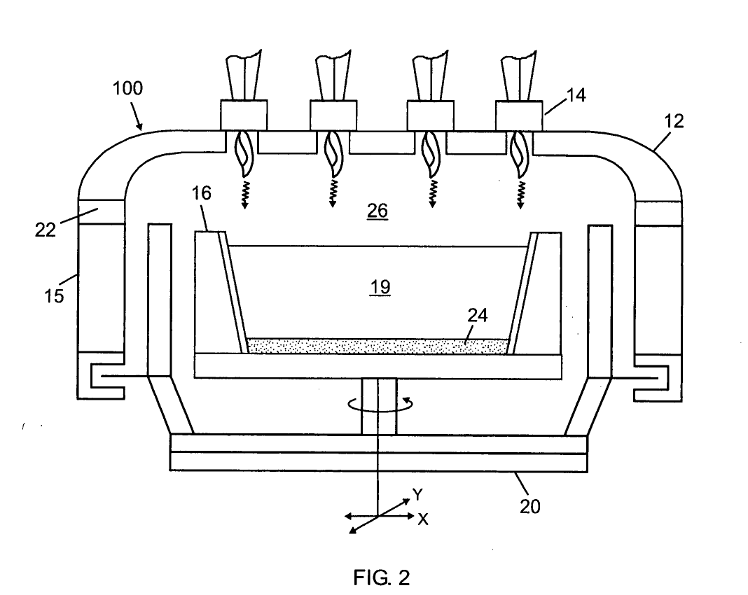

As practiced commercially, boules having diameters on the order of five feet (1.5 meters) and thicknesses on the order of 5-10 inches (13-25 cm) can be produced using furnaces of the type shown in FIG. 2. In brief overview, furnace 100 includes a crown 12 which carries a plurality of burners 14 which produce silica soot. The crown 12 is supported on a stationary wall 15. A containment vessel 16 is disposed within the stationary wall 15 below the burners 14. The silica soot produced by the burners 14 is deposited on bait sand 24 inside the containment vessel 16 to form boule 19, which, as noted before, is typically on the order of five feet (1.5 meters) in diameter. As the silica soot is deposited in the containment vessel 16, the containment vessel 16 may be rotated and/or oscillated through its attachment to an oscillation table 20. The space or plenum 26 between the top of the containment vessel 16 and the crown 12 is vented by a plurality of vents 22 formed at the top of the stationary wall 15. Further details on the structure and operation of furnaces of this type may be found in commonly assigned U.S. Pat. No. 5,951,730 (issued to Schermerhorn), the entire contents of which are incorporated herein by reference. Particular details on burner configurations for making fused silica boules may be found in commonly-assigned PCT International Publication Number WO 00/17115.

Applicants have surprisingly discovered that by adjusting the burner flows in the boule manufacturing furnace so that the hydrogen concentration of the finished boule is lowered to less than 3.0×10¹⁷ molecules/cm³ as measured by Raman spectroscopy results in a blank having a higher transmission than conventional boules. According to the conventional process, burner flows were generally maintained so that the hydrogen concentration in the boule was as high as 5×10¹⁷ molecules/cm³. In another aspect of the invention, applicants have discovered that by further lowering the metals impurities contained in the zircon refractories in a standard boule production furnace, internal transmission of fused silica members manufactured from such boules is improved. Commonly assigned U.S. Pat. No. 6,174,509, the entire contents of which are incorporated herein by reference, describes a process for removing metals impurities from zircon refractory brick to a level below 300 parts per million (ppm). Applicants have discovered that by utilizing the process described in U.S. Pat. No. 6,174,509 to calcine the refractories used in the boule furnace for a longer period of time to lower impurities in the refractory material, internal transmission of the fused silica is improved. It is preferred that the impurities in the refractories are lowered so that sodium is less than 2 ppm, potassium is less than 2 ppm and iron is less than 5 ppm. The time and conditions of each treatment will vary depending on the level of impurities in the as-received refractory materials and can be determined by experimentation.

Measurement of internal transmission, homogeneity and birefringence were performed as follows. In unexposed fused silica, the internal transmittance is determined using a suitable UV spectrophotometer (e.g., Hitachi U4001) on optically polished samples. The internal transmittance (Ti) is determined by the measured transmission through the sample, divided by the theoretical transmission of such a sample as determined by surface reflections and then normalized to a 10 mm path length. The transmission of fused silica members produced in accordance with the present invention exhibited internal transmission exceeding 99.65%/cm and 99.75%/cm.

Homogeneity, represented by wavefront distortion and caused by refractive index inhomogeneities, is measured using a commercial phase measuring interferometer with a HeNe laser at a wavelength of 632.8 nm. The lens blanks are thermally stabilized. The surfaces are either polished or made transparent by utilizing index-matching oil. The surface shapes of all optics in the interferometer cavity and the refractive index variations of the sample will result in a total wavefront distortion measured by the interferometer. Techniques known to those skilled in the art are used to correct for systematic errors due to the surfaces and to calculate the refractive index inhomogeneity. The result is a map of relative variations of refractive index of the part. In optical applications, such aberrations can be, and frequently are, represented by Zernike polynomials. Fused silica members produced in accordance with the present invention should have homogeneity values along the use axis in the range of less than 1.0 ppm with Zernikes piston and x-y tilt removed, less than 0.9 ppm with Zernikes piston, x-y tilt and power removed, and less than 0.7 ppm with Zernikes piston, x-y tilt, power and astigmatism removed.

Birefringence can be measured using a HINDS EXICOR™ birefringence measuring system or a similar system known in the art that is capable to measure the birefringence on user-selected locations of the sample, with a sensitivity better than 0.02 nm. The system simultaneously determines both the birefringent magnitude and direction in a sample utilizing a photoelastic modulator for modulating the polarization states of a HeNe laser beam. After the modulated laser beam passes through the sample, two detecting channels analyze the polarization change caused by the sample. HINDS's EXICOR™ software then calculates and analyzes the measurement data. The birefringence of fused silica members produced in accordance with the present invention should be less than 0.5 nm/cm absolute maximum and less than 0.25 nm/cm absolute average along the use axis.

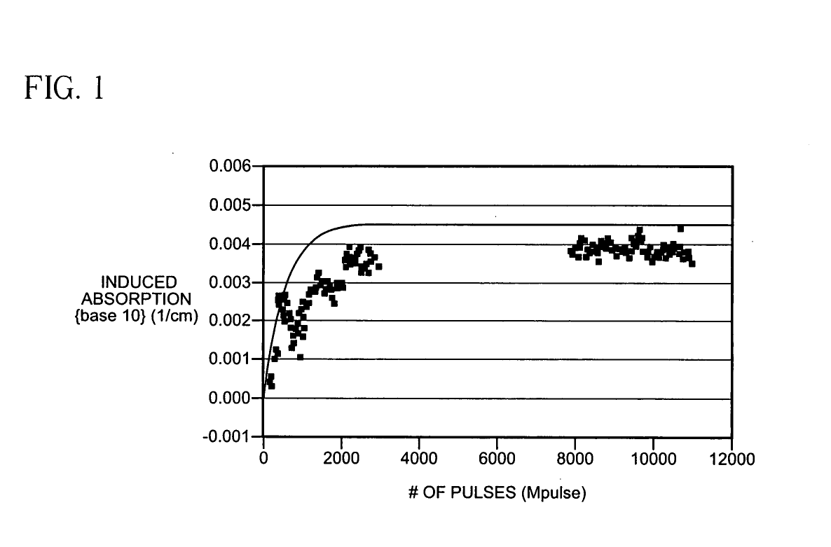

Fused silica members produced in accordance with the present invention can be predicted using a limited lifetime model that depends on material properties, rate constants, fluence and the number of exposure pulses. Actual performance of the material can be verified using related material properties, process parameters and test exposure of samples. FIG. 1 is a representative plot of induced absorption versus number of pulses for fused silica irradiated with a 193 nm laser. The line in FIG. 1 represents data according to a model, and the data points in FIG. 1 represent measurements on fused silica produced in accordance with Example 1 below.

Transmittance loss (Δk (base 10)) as defined as change in transmittance before and after exposure with a 193 excimer laser. Fused silica produced in accordance with the present invention should exhibit Δk less than or equal to 0.005/cm when irradiated with 10¹⁰ pulses at 1.0 mJ/cm²/pulse (as shown in FIG. 1), and under a lifetime model, Δk less than 0.0006/cm after irradiation with 10¹¹ pulses at 0.1 mJ/cm²/pulse and less than 0.0050/cm after 10¹¹ pulses at 1.0 mJ/cm²/pulse. A modeling technique for measuring transmittance loss is described in the article entitled, “Induced Absorption in Silica (A Preliminary Model),” Araujo, R. J, Borrelli, N. F., and Smith, C., Proceedings of SPIE Vol. 3424 Inorganic Optical Materials 1998, pages 1-9.

Without intending to limit the invention in any manner, the present invention will be more fully described by the following examples.

### EXAMPLES

### EXAMPLE 1

Preparation of High Transmission, Low Birefringent Fused Silica Using Standard Process

Fused silica boules were made in furnace as shown in FIG. 2. Further details on the structure and operation of furnaces of this type may be found in commonly assigned U.S. Pat. No. 5,951,730. Burner flows were held to obtain hydrogen content in the boule to less than 3×10¹⁷ molecules/cm³ and OH content greater than 300 ppm. Particular details on burner configurations for making fused silica boules may be found in commonly-assigned PCT patent publication number WO 00/17115. Applicants have discovered that by calcining the refractory materials used in the production furnace for a period of time sufficient to lower the sodium, potassium and iron impurity levels to less than 2 ppm, 2 ppm and 5 ppm respectively results in a fused silica having greatly improved transmission. Table I shows the minimum transmission, maximum birefringence, and homogeneity measurements for fused silica prepared according to this process. The homogeneity measurement was measured with Zernikes piston and x-y tilt removed. The homogeneity and the maximum absolute birefringence measurement was performed along the use axis.

TABLE I

| | | | | Composition | |
|---|---|---|---|---|---|
| | | | | H₂ | |
| | Transmission | Homogeneity | Birefringence | (10¹⁷ | OH |
| | (%/cm) | (ppm) | (nm/cm) | molecules/cc) | (ppm) |
| Sample 1 | 99.70 | 0.59 | 0.18 | 2.4 | 860-890 |
| Sample 2 | 99.70 | 0.57 | 0.18 | 2.4 | 860-890 |
| Sample 3 | 99.69 | 0.64 | 0.24 | 2.4 | 860-890 |
| Sample 4 | 99.69 | 0.40 | 0.30 | 2.3 | 860-890 |
| Sample 5 | 99.68 | 0.39 | 0.26 | 2.5 | 860-890 |
| Sample 6 | 99.70 | 0.57 | 0.10 | 2.4 | 860-890 |
| Sample 7 | 99.69 | 0.43 | 0.15 | 2.3 | 860-890 |
| Sample 8 | 99.69 | 0.52 | 0.17 | 2.3 | 860-890 |
| Sample 9 | 99.68 | 0.32 | 0.20 | 2.5 | 860-890 |

### EXAMPLE 2

Preparation of High Transmission, Low Birefringent Fused Silica Using Modified Furnace

A modified furnace was used to produce fused silica in accordance with the present invention. More details on the furnace and its operation may be found in co-pending patent application entitled, “Improved Methods and Furnaces for Fused Silica Production,” naming Marley, Sproul, and Sempolinski, as inventors and commonly assigned to the assignee of the present invention, the entire contents of which are incorporated herein by reference. Transmission was measured at radial locations 7, 9, 14, 21, 23 and 25 inches from the center of the boule, and in each case internal transmission exceeded 99.74%/cm. Based on these measurements, it is envisioned that this process can produce fused silica in production quantities having a minimum internal transmission exceeding 99.75%/cm. The minimum value for each sample is reported in Table II. Preliminary observations and experience indicate that the birefringence of these samples is expected to be less 0.5 nm/cm along the use axis.

TABLE II

| | Transmission (%/cm) |
|---|---|
| Sample 10 | 99.75 |
| Sample 11 | 99.76 |
| Sample 12 | 99.74 |

Fused silica produced using a standard production process typically exhibits a transmission of up to 99.6%/cm. Considering the fact that the theoretical maximum transmission of fused silica is 99.85%/cm, the internal transmission values achieved by using the modified furnace according to this example represent a marked improvement over the standard process. Preliminary observations and experience indicate that the birefringence of these samples is expected to less 0.5 nm/cm along the use axis.

It will be apparent to those skilled in the art that various modifications and variations can be made to the present invention without departing from the spirit or scope of the invention. Thus, it is intended that the present invention covers modifications and variations of this invention provided they come within the scope of the appended claims and their equivalents.

What is claimed is:

1. A fused silica glass member resistant to optical damage in ultraviolet radiation in the wavelength range between 190 and 300 nm having an internal transmission greater than or equal to 99.65%/cm at a wavelength of 193 nm an absolute maximum birefringence along the use axis of less than or equal to 0.75 nm/cm, H₂ content less than 5×10¹⁷ molecules/cc, and OH content greater than 300 ppm.

2. The fused silica glass member of claim 1, wherein the fused silica member has a refractive index homogeneity along the use axis less than or equal to 1 ppm.

3. The fused silica member of claim 2, wherein the fused silica member exhibits a change in transmittance of less than 0.005/cm after the member has been irradiated with 1×10¹⁰ shots of 193 nm laser at 1.0 mJ/cm²/pulse.

4. The fused silica glass member of claim 1, wherein the fused silica member has a hydrogen molecule content less than or equal to 2.5×10¹⁷ molecules/cm³.

5. The fused silica member of claim 1, wherein the member is used as a lens in a photolithographic system.

6. A fused silica glass member resistant to optical damage in ultraviolet radiation in the wavelength range between 190 and 300 nm having an internal transmission greater than or equal to 99.75%/cm at a wavelength of 193 nm, an absolute maximum birefringence along the use axis of less than or equal to 0.5 nm/cm, H₂ content less than 5×10¹⁷ molecules/cc, and OH content greater than 300 ppm.

7. The fused silica glass member of claim 6, wherein the fused silica member has a refractive index homogeneity along the use axis less than or equal to 1 ppm.

8. The fused silica member of claim 7, wherein the fused silica member exhibits a change in transmittance of less than 0.005/cm after the member has been irradiated with 1×10¹⁰ shots of 193 nm laser at 1.0 mJ/cm²/pulse.

9. The fused silica glass member of claim 6, wherein the fused silica member has a hydrogen molecule content less than or equal to 2.5×10¹⁷ molecules/cm³.

10. The fused silica member of claim 6, wherein the member is used as a lens in a photolithographic system.
